(19) United States
(12) Patent Application Publication
(10) Pub. No.: US 2014/0103991 A1
(43) Pub. Date: Apr. 17, 2014

(54) BOUNDED BIAS CIRCUIT WITH EFFICIENT VT-TRACKING FOR HIGH VOLTAGE SUPPLY/LOW VOLTAGE DEVICE

(71) Applicant: LSI CORPORATION, Milpitas, CA (US)

(72) Inventors: Anuroop Iyengar, Bangalore (IN); Pankaj Kumar, Bangalore (IN)

(73) Assignee: LSI CORPORATION, Milpitas, CA (US)

(21) Appl. No.: 13/649,915

(22) Filed: Oct. 11, 2012

(51) Int. Cl. G05F 3/02

(52) U.S. Cl. CPC G05F 3/02
USPC 327/537

(57) ABSTRACT

Disclosed is a device and method for providing a bounded bias voltage with improved Process Voltage Temperature (PVT) adjustment. An embodiment may include a bias_n generation circuit that adjusts a bias_n voltage for PVT as a function of two bias_n NMOS transistors/diodes and a bias_p generation circuit that adjusts a bias_p voltage for PVT as a function of two bias_p PMOS transistors/diodes. An embodiment may further include a PVT adjusted bounded bias voltage circuit comprised of a NMOS transistor with the bias_n voltage at the gate and a PMOS transistor with the bias_p voltage at the gate such that a common connection between the NMOS and PMOS transistors generates a bounded bias voltage adjusted for PVT as a function of two body biased voltages (bias_n/bias_p). The bounded bias voltage may be used to provide a low supply voltage to a low voltage device using an available high voltage supply.

### BACKGROUND OF THE INVENTION

An Integrated Circuit (IC) is typically made up of individual electrical elements and typically includes active elements such as one or more transistor devices. Typical operation of a transistor requires connection of the transistors either directly or through other electrical devices to a high and a low output of a voltage supply. Typically, the high output of the voltage supply is identified as the high voltage supply and the low output of the voltage supply is identified as the low voltage supply. For an IC based on Metal-Oxide-Semiconductor Field-Effect Transistors (MOSFETs), it is common to refer to the high supply voltage as VDD (or VDDIO as used within this document) and to refer to the low supply voltage as VSS. Many if not most, times VSS is also referred to and defined as the electrical ground for a circuit. Typical operation of a MOSFET device involves the application of high (VDD) and or low (VSS) supply voltages to the gate, source, and/or drain either directly or through other electrical circuit devices. MOSFET devices are typically divided into two major subdivisions, PMOS devices and NMOS devices which have related, but different operation characteristics. While initially tied to MOSFET based circuits, the use of VDD and VSS to represent the high and low voltage outputs, respectively, has become common usage even for non-MOSFET based circuits.

### SUMMARY OF THE INVENTION

An embodiment of the present invention may comprise a method to provide a bounded bias voltage with improved Process-Voltage-Temperature (PVT) adjustment comprising: generating a PVT adjusted bias_n voltage at a bias_n output of a bias_n voltage generation circuit that adjusts for Process-Voltage-Temperature (PVT) as a function of temperature affected voltages of a first bias_n NMOS diode (MNBN1) and a second bias_n NMOS diode (MNBN2), the generation of the bias_n voltage further comprising: connecting in series between a high voltage supply (VDDIO) and a low voltage supply (VSS) the following electrical components in the following order: a first bias_n resistor (RN1), a first bias_n NMOS diode (MNBN1), a second bias_n NMOS diode (MNBN2), and a second bias_n resistor (RN2), connected such that the first bias_n NMOS diode (MNBN1) and the second bias_n NMOS diode (MNBN2) are placed to permit current to flow from the high voltage supply (VDDIO) to the low voltage supply (VSS) and a resistance of the first bias_n resistor (RN1) is substantially equal to a resistance of the second bias_n resistor (RN2); connecting the bias_n voltage output substantially electrically at the junction/connection between the first bias resistor (RN 1) and the first bias_n NMOS diode (MNBN1) in order to permit Process-Voltage-Temperature (PVT) variations of threshold voltages that vary with temperatures of the first (MNBN1) and the second (MNBN2) bias_n NMOS diodes to vary the PVT adjusted bias_n voltage at the bias_n voltage output; and operating the high voltage supply (VDDIO) and the low voltage supply (VSS) such that the PVT adjusted bias_n voltage is generated at the bias_n output of the bias_n voltage generation circuit; generating a PVT adjusted bias_p voltage at a bias_p output of a bias_p voltage generation circuit as a function of temperature affected voltages of a first bias_p PMOS transistor (MPBP1) and a second bias_p PMOS transistor (MPBP2), the generation of the bias_p voltage further comprising: connecting in series between the high voltage supply (VDDIO) and the low voltage supply (VSS) the following electrical components in the following order: a first bias_p resistor (RP1), a first bias_p PMOS diode (MPBP1), a second bias_p PMOS diode (MPBP2), and a second bias_p resistor (RP2), connected such that the first bias_p PMOS diode (MPBP1) and the second bias_p PMOS diode (MPBP2) are placed to permit current to flow from the high voltage supply (VDDIO) to the low voltage supply (VSS) and a resistance of the first bias_p resistor (RP1) is substantially equal to a resistance of the second bias_p resistor (RP2); connecting the bias_p voltage output substantially electrically at the junction/connection between the second bias_p PMOS diode (MPBP2) and the second bias_p transistor (RP2) in order to permit Process-Voltage-Temperature (PVT) variations of threshold voltages that vary with temperatures of the first (MPBP1) and the second (MPBP2) bias_p PMOS diodes to vary the PVT adjusted bias_p voltage at the bias_p voltage output; and operating the high voltage supply (VDDIO) and the low voltage supply (VSS) such that the PVT adjusted bias_p voltage is generated at the bias_p output of the bias_p generation voltage generation circuit; generating a PVT adjusted bounded bias voltage at a bounded bias voltage output of a bounded bias voltage generation circuit, the generation of the bounded bias voltage further comprising: connecting a drain of a first bounded bias NMOS transistor (MN1) to the high voltage supply (VDDIO); connecting a gate of the first bounded bias NMOS transistor (MN1) to the bias_n voltage output of the bias_n voltage generation circuit such that the PVT adjusted bias_n voltage is applied to the gate of the first bounded bias NMOS transistor (MN1); connecting a source of the first bounded bias NMOS transistor (MNBB 1) to a source of a first bounded bias PMOS transistor (MPBB 1) such that the common connection of the source of the first bounded bias NMOS transistor (MNBB1) and the source of the first bounded bias PMOS transistor (MPBB1) substantially electrically comprise the bounded bias voltage output of the bounded bias voltage generation circuit; connecting a gate of the first bounded bias PMOS transistor (MPBB1) to the bias_p voltage output of the bias_p voltage generation circuit such that the PVT adjusted bias_p voltage is applied to the gate of the first bounded bias PMOS transistor (MPBB 1); connecting a drain of the first bounded bias PMOS transistor (MPBB1) to the low voltage supply (VSS); and operating the high voltage supply (VDDIO), the low voltage supply (VSS), the bias_n voltage generation circuit, and the bias_p voltage generation circuit such that the PVT adjusted bounded bias voltage is generated at the bounded bias voltage output of the bounded bias voltage generation circuit.

An embodiment of the present invention may further comprise a bounded bias voltage apparatus that provides a bounded bias voltage with improved Process-Voltage-Temperature (PVT) adjustment comprising: a bias_n voltage generation circuit that generates a PVT adjusted bias_n voltage at a bias_n output of the bias_n voltage generation circuit that adjusts for Process-Voltage-Temperature (PVT) as a function of temperature affected voltages of a first bias_n NMOS diode (MNBN1) and a second bias_n NMOS diode (MNBN2), the bias_n voltage generation circuit further comprising: a first bias_n resistor (RN1), a first bias_n NMOS diode (MNBN1), a second bias_n NMOS diode (MNBN2), and a second bias_n resistor (RN2) connected in order in series between a high voltage supply (VDDIO) and a low voltage supply (VSS), further connected such that the first bias_n NMOS diode (MNBN1) and the second bias_n NMOS diode (MNBN2) are placed to permit current to flow from the high voltage supply (VDDIO) to the low voltage supply (VSS) and a resistance of the first bias_n resistor (RN1) is substantially equal to a resistance of the second bias_n resistor (RN2), the bias_n voltage output connected substantially electrically at the junction/connection between the first bias resistor (RN1) and the first bias_n NMOS diode (MNBN1) in order to permit Process-Voltage-Temperature (PVT) variations of threshold voltages that vary with temperatures of the first (MNBN1) and the second (MNBN2) bias_n NMOS diodes to vary the PVT adjusted bias_n voltage at the bias_n voltage output, and such that operation of the high voltage supply (VDDIO) and the low voltage supply (VSS) generates the PVT adjusted bias_n voltage at the bias_n output of the bias_n voltage generation circuit; a bias_p voltage generation circuit that generates a PVT adjusted bias_p voltage at a bias_p output of the bias_p voltage generation circuit as a function of temperature affected voltages of a first bias_p PMOS transistor (MPBP1) and a second bias_p PMOS transistor (MPBP2), the bias_p voltage generation circuit further comprising: a first bias_p resistor (RP1), a first bias_p PMOS diode (MPBP1), a second bias_p PMOS diode (MPBP2), and a second bias_p resistor (RP2) connected in order in series between the high voltage supply (VDDIO) and the low voltage supply (VSS), further connected such that the first bias_p PMOS diode (MPBP1) and the second bias_p PMOS diode (MPBP2) are placed to permit current to flow from the high voltage supply (VDDIO) to the low voltage supply (VSS) and a resistance of the first bias_p resistor (RP1) is substantially equal to a resistance of the second bias_p resistor (RP2), the bias_p voltage output connected substantially electrically at the junction/connection between the second bias_p PMOS diode (MPBP2) and the second bias_p transistor (RP2) in order to permit Process-Voltage-Temperature (PVT) variations of threshold voltages that vary with temperatures of the first (MPBP1) and the second (MPBP2) bias_p PMOS diodes to vary the PVT adjusted bias_p voltage at the bias_p voltage output, and such that operation of the high voltage supply (VDDIO) and the low voltage supply (VSS) generates the PVT adjusted bias_p voltage at the bias_p output of the bias_p generation voltage generation circuit; a bounded bias voltage generation circuit that generates a PVT adjusted bounded bias voltage at a bounded bias voltage output of the bounded bias voltage generation circuit, the bounded bias voltage generation circuit further comprising: a first bounded bias NMOS transistor (MNBB1) having a drain connected to the high voltage supply (VDDIO), having a gate connected to the bias_n voltage output of the bias_n voltage generation circuit such that the PVT adjusted bias_n voltage is applied to the gate of the first bounded bias NMOS transistor (MNBB1); a first bounded bias PMOS transistor (MPBB1) having a source connected to a source of the first bounded bias NMOS transistor (MNBB1) such that the common connection of the source of the first bounded bias NMOS transistor (MNBB1) and the source of the first bounded bias PMOS transistor (MPBB 1) substantially electrically comprise the bounded bias voltage output of the bounded bias voltage generation circuit, the first bounded bias PMOS transistor (MPBB 1) further having a gate connected to the bias_p voltage output of the bias_p voltage generation circuit such that the PVT adjusted bias_p voltage is applied to the gate of the first bounded bias PMOS transistor (MPBB1), the first bounded bias PMOS transistor (MPBB1) further having a drain connected to the low voltage supply (VSS), and such that operation of the high voltage supply (VDDIO), the low voltage supply (VSS), the bias_n voltage generation circuit, and the bias_p voltage generation circuit generates the PVT adjusted bounded bias voltage at the bounded bias voltage output of the bounded bias voltage generation circuit.

### BRIEF DESCRIPTION OF THE DRAWINGS

In the drawings,

FIG. 1 is an electrical schematic illustration of a resistor divider voltage bias circuit.

FIG. 2 is an electrical schematic illustration of a resistor divider based bounded bias voltage circuit.

FIG. 3A is an electrical schematic illustration of a Process Voltage Temperature (PVT) adjusted bias_n voltage generation circuit for an embodiment.

FIG. 3B is an electrical schematic illustration of a PVT adjusted bias_p voltage generation circuit for an embodiment.

FIG. 3C is an electrical schematic illustration of a bounded bias voltage circuit based on PVT adjusted voltage inputs bias_n and bias_p.

FIG. 4 is graph of bias voltage curves for operation of an embodiment of a PVT adjusted bounded bias circuit while the external PAD is cycled to upper and lower limits.

FIG. 5 is a graphical comparison of operation of a PVT adjusted bounded bias voltage circuit of an embodiment to a resistor divider based bounded bias voltage circuit.

FIG. 6 is a graph of bias currents across bounding process corners showing better voltage temperature tracking for an embodiment.

### DETAILED DESCRIPTION OF THE EMBODIMENTS

When electronic devices first began to use Integrated Circuits (ICs) to provide the functionality for the end electronic device (i.e., the end device), a typical application obtained power from a wall plug, which essentially amounted to an unlimited power source for the end device. Relatively quickly, consumer demand for portable devices not dependent on a wall plug resulted in end devices being powered by various battery systems that represented finite power sources relative to the end device. Thus, there came a drive to make the ICs as energy efficient as possible so as to extend the life of the end device by using less battery power. One way IC manufacturers reduced power consumption on the ICs was to reduce the voltage requirements for the IC logic and power supplies. For instance, 5 volt logic/supplies may have migrated to 3.3 volt logic/supplies, and then migrated further to 1.7 volt logic/supplies.

While some IC chips may operate at lower voltages, it is not uncommon for one or more other IC chips necessary to provide the overall desired functionality of an end device to operate at one of the older/higher voltages. Further, as standards are slower to change than individual pieces of technology (e.g., particular IC chips), some Input/Output (JO) communication standards often require higher voltages than many of the IC chips that drive the logic/end device implementing the communication standard, Thus, for many systems, it may be beneficial to have two, or more, voltage supplies to operate the various components and sub-components of the system. However, it is often undesirable to have to implement two or more voltage supplies and the required traces/wiring necessary to supply the multiple voltage supplies on a system. Therefore, it may be desirable for a system to implement a voltage conditioning system that converts a high voltage supply to a lower voltage to power an individual device. The voltage conditioning circuitry may be implemented either outside the lower voltage IC-component-device, or, preferably to the end user, the voltage conditioning circuitry may be included at the voltage supply input for the lower voltage IC-component-device. Further, it may also be desirable to have both high voltage and low voltage circuitry in an individual IC, so an IC may implement the lower voltage conditioning circuitry for a portion/sub-system of the IC while still permitting other circuitry to use the higher voltage supply.

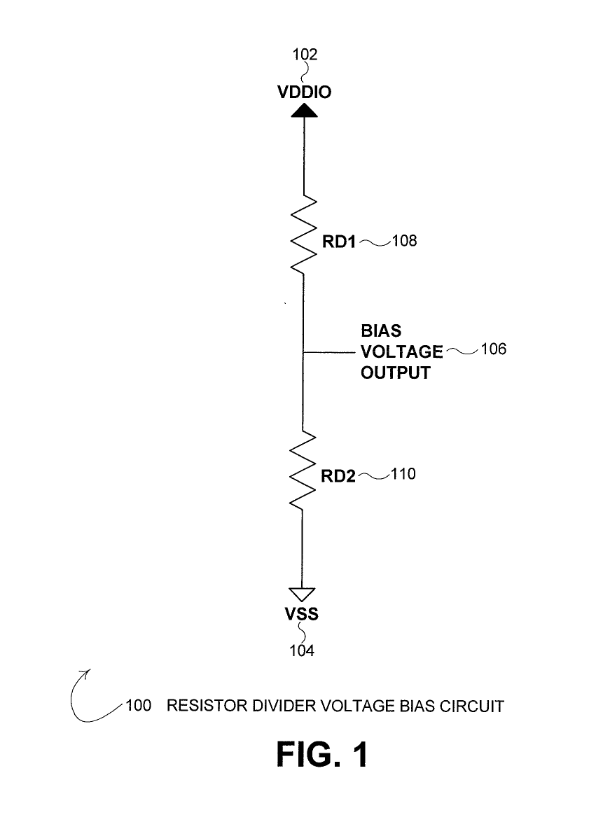

FIG. 1 is an electrical schematic illustration of a resistor divider voltage bias circuit 100. The resistor divider voltage circuit 100 represents one simple means of providing a lower bias voltage 106 based on a higher voltage input (VDDIO) 102. In the simple voltage divider circuit 100, the difference between the high voltage supply VDDIO 102 and the low voltage supply VSS 104 is split as a ratio of RD1 (108) and RD2 (110). The connection/electrical node between RD1(108) and RD2 (110) may be used to provide the desired bias voltage output 106 that is a fraction of the voltage difference between the high voltage supply VDDIO 102 and the low voltage supply VSS 104. The low voltage supply VSS 104 is typically electrical ground (or zero volts) for the circuit. Consequently, for the remainder of the discussion of FIG. 1, herein, the high supply VDDIO 102 will be assumed to be the input voltage for the resistor divider circuit 100. Thus, according to the generally accepted Ohm's (resistors) and Kirchhoff's (circuit analysis) laws for electrical circuits/devices, the bias voltage output (Vbiasout) 106 may be said to follow Eq. 1 below.

$$Vbiasout = VDDIO ( \frac{RD 2}{RD 1 + RD 2} ) \qquad Eq . 1$$

While the resistor divider circuit 100 shown in FIG. 1 may be used to supply a lower voltage based on the VDDIO 102 input voltage, there are some potential problems. The generated bias voltage output (Vbiasout) 106 may be used as both a source for lower voltage circuitry as well as at an interface from the chip to the outside world at a bond-pad (also commonly referred to as a PAD) in order to help alleviate potential reliability issues between internal and external voltage levels. Because the generated bias voltage output 106 may be used as both a source and at an external PAD, the bias voltage output 106 may experience/have induced significant amounts of noise. One potential means to eliminate the noise is to generate a high current resistor divider circuit, but this has a penalty on the power used. Further, since noise is not completely eliminated in a given cycle there may be common mode voltage bias shifts, which may result in propagation delay between different cycles and contribute to potential jitter for circuit operation. Also, in some applications where a pattern of disable and defined states (either “1” or “0”) are provided for a long time, the bias voltage may start to drift from the desired DC (Direct Current) value, which may lead to a functional failure and/or other reliability issues for a device. Due to the potential problems with a strictly resistor divider circuit, it may be desirable to provide a bias voltage circuit that provides noise suppression and that consumes less current while still suppressing noise.

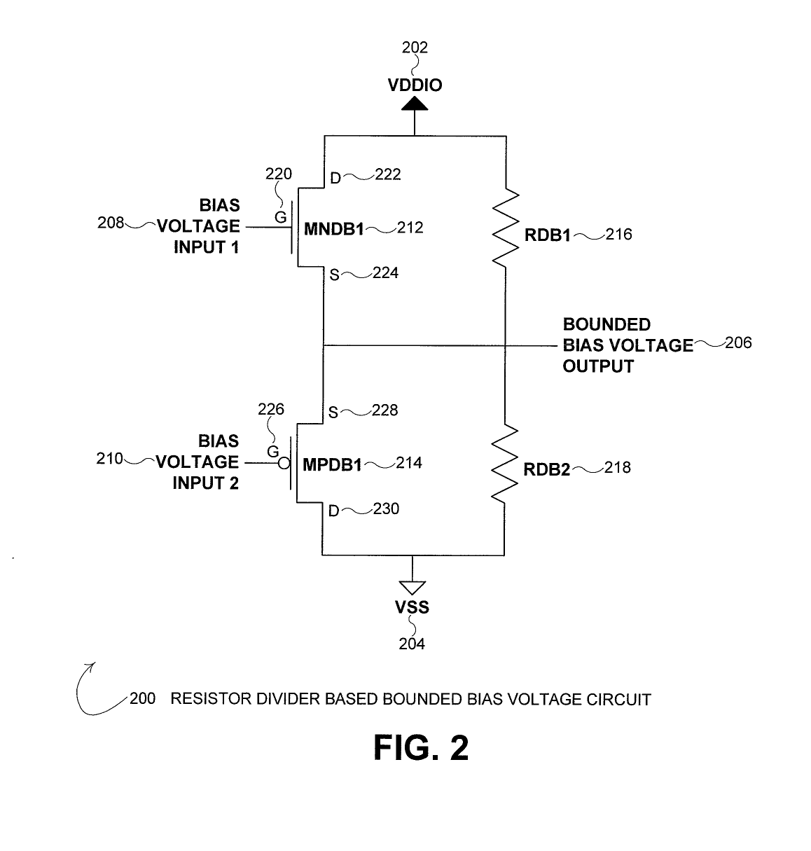

FIG. 2 is an electrical schematic illustration of a resistor divider based bounded bias voltage circuit 200. In the circuit shown in FIG. 2, the NMOS transistor MNDB1(212) and the PMOS transistor MPDB2 (214) provide active circuit components that may provide noise suppression for the circuit. As shown in FIG. 2, the drain 222 of the NMOS transistor MNDB1 (212) is connected to the high voltage supply VDDIO 202. The drain 230 of PMOS transistor MPDB1 (214) is connected to the low voltage supply VSS 204, which is assumed to be electrical ground (i.e., zero volts) for the remainder of the discussion of FIG. 2. The source 224 of NMOS transistor MNDB1 (212) is tied to the source 228 of PMOS transistor MPDB1 (214). There is also a resistor divider circuit made up of resistor RDB 1 (216) and RDB2 (218) tied together and connected between the high voltage supply VDDIO 202 and the low voltage supply/ground VSS 204. Accordingly, the connection of RDB1 (216) to the high voltage supply VDDIO 202 is shared as an electrical node with the connection of the drain 222 of NMOS transistor MNDB1 (212) and the connection of RDB2 (218) to the low voltage supply VSS (204) is shared as an electrical node with the connection of the drain 230 of PMOS transistor MPDB1 (214). The connection of the sources 224, 228 of the NMOS transistor MNDB1 (212) and the PMOS transistor MPDB1 (214) is also tied to the connection between the resistors RDB1 (216) and RDB2 (218) to create a single electrical node that also operates to provide the bounded bias voltage output 206. Bias voltage input 1 (208) is connected to the gate 220 of the NMOS transistor MNDB 1 (212) and bias voltage input 2 (210) is connected to the gate 226 of the PMOS transistor MPDB1 (214). For a typical system, bias voltage input 1 (208) is set to roughly 70% of VDDIO (202) and bias voltage input 2 (210) is set to roughly 30% of VDDIO (202). The bias voltage inputs 1 and 2 (208 and 210) may be set using a standard resistor divider circuit such as that shown in FIG. 1. The resistor divider circuit element made up of resistors RDB 1 (216) and RDB2 (218) may size the resistors RDB1 (216) and RDB2 (218) such that the bounded bias voltage output 206 delivers the lower desired voltage while the active circuit elements of transistors MNDB 1 (212) and MPDB 1 (214) provide noise suppression of the bounded bias voltage output 206.

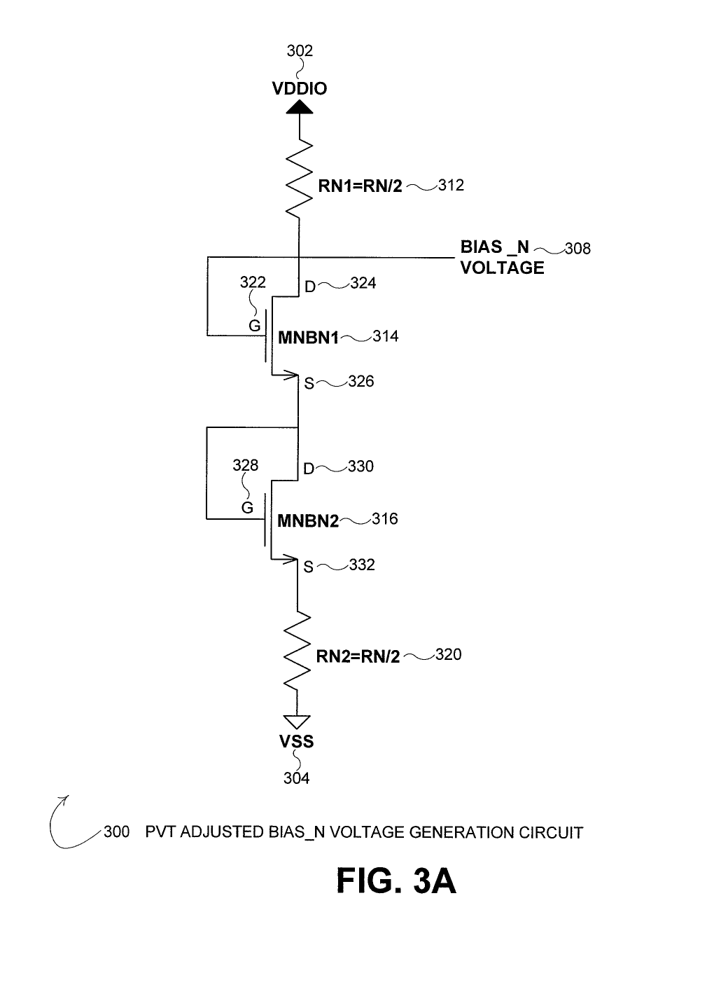

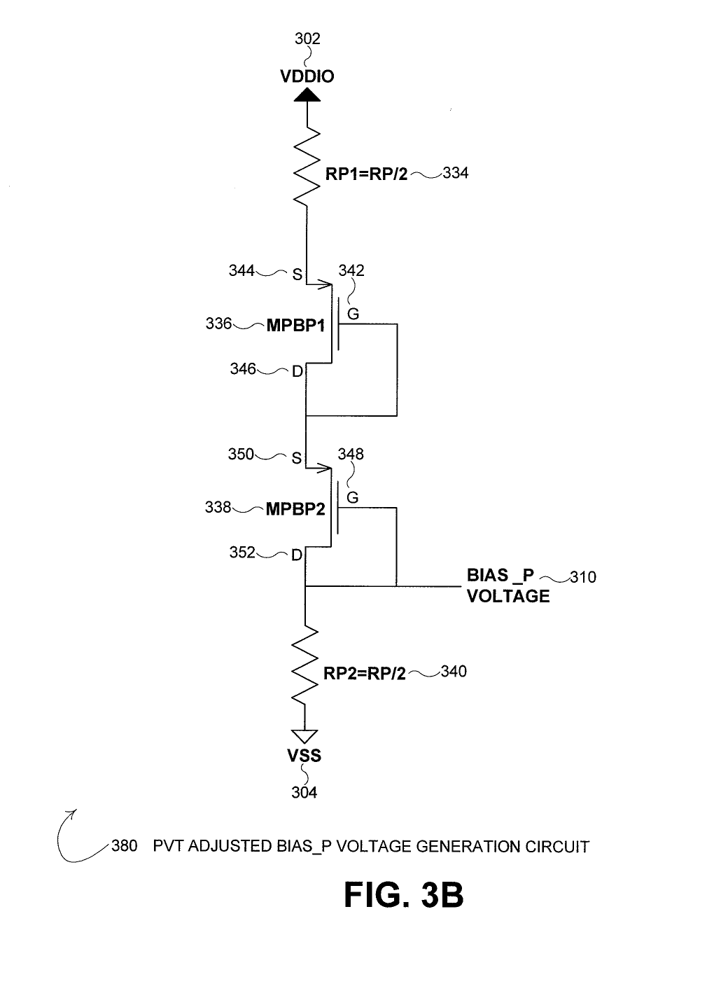

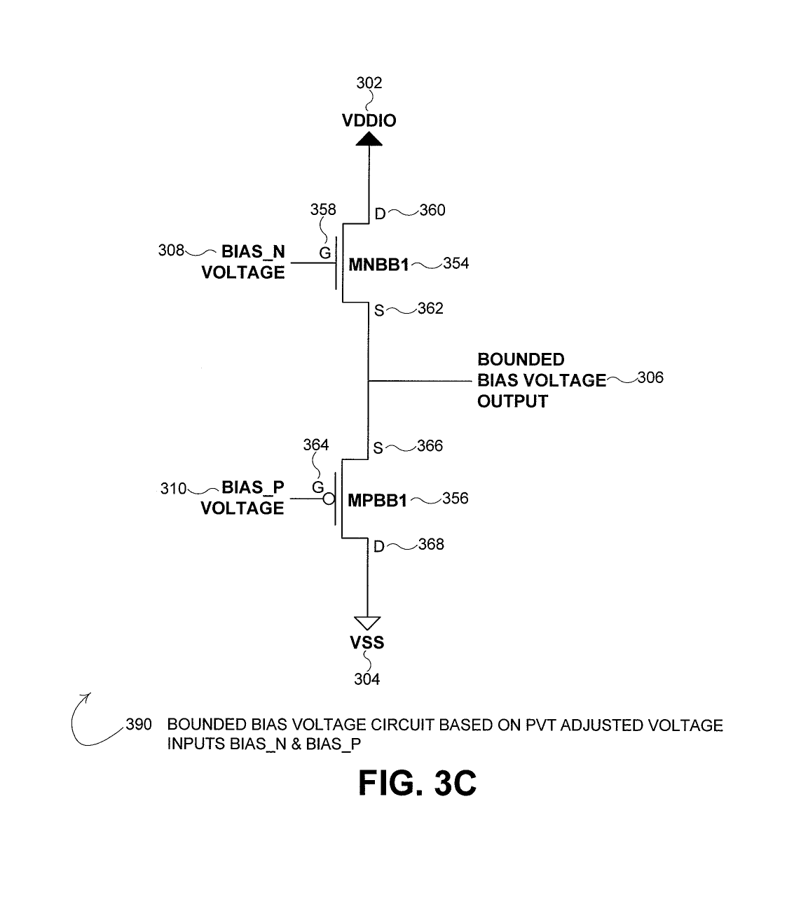

While a system such as the circuit 200 shown in FIG. 2 may provide noise suppression for the bounded bias voltage output 206, the bounded bias voltage output 206 does not adjust across process or temperature. Hence, the bounded bias voltage output 206 keeps changing with changes in Process-Voltage-Temperature (PVT) variations. However, an embodiment such as the entire circuit described in FIGS. 3A-C provides a system/circuit that permits a bounded bias voltage to adjust with PVT variations as is described in the description with respect to FIGS. 3A and 3B below.

FIG. 3A is an electrical schematic illustration of a Process Voltage Temperature (PVT) adjusted bias_n voltage generation circuit 300 for an embodiment. As shown in FIG. 3A, in the PVT adjusted bias_n voltage generation circuit 300, resistor RN1 (312) is connected to the high supply voltage VDDIO 302 at one end and is further connected at the other end of resistor RN1 (312) to the drain 324 and gate 322 of the first NMOS bias_n transistor MNBN1 (314). The common connection of resistor RN1 (312) and the gate 322 and drain 324 of the first NMOS bias_n transistor MNBN1 (314) is substantially an electrical node that is also the bias_n voltage that will be applied to the gate 358 of the first NMOS bounded bias circuit transistor MNBB1 (354) in FIG. 3C. The source 326 of the first NMOS bias_n transistor MNBN1 (314) is connected to the gate 328 and drain 330 of the second NMOS bias_n transistor MNBN2 (316). The source 332 of the second NMOS bias_n transistor MNBN2 (316) is connected to one end of resistor RN2 (320) while the other end of resistor RN2 (320) is connected to the low voltage supply VSS 304. As with the other example circuits, the low voltage supply VSS will be assumed to be at electrical ground (i.e., zero volts) for the remainder of the description of the embodiment(s) shown in FIGS. 3A-C.

Resistors RN1 (312) and RN2 (320) should have substantially equal resistance values for the various embodiments. Thus, for an overall resistance of RN, RN1 (312) substantially equals one half of RN, and RN2 (320) also substantially equals one half of RN. The NMOS bias_n transistors MNBN1 (314) and MNBN2 (316) are connected as NMOS diodes 314, 316 in series between the high voltage supply VDDIO 302 and the low voltage supply VSS 304 such that the NMOS diodes 314, 316 are placed such that current (i.e., the variable “I” in mathematical representations of the circuit) is permitted to flow from the high voltage supply VDDIO 302 to the low voltage supply VSS 304. The resistors RN1 (312) and RN2 (320) are also connected in series with the NMOS diodes 314, 316 such that RN1 (312) is placed between the transistor/diode MNBN1 (314) and VDDIO 302 and RN2 (320) is placed between the transistor/diode MNBN2 (320) and VSS 304. Thus, with the resistance RN split substantially in half between the NMOS bias_n transistors/diodes MNBN1 (314) and MNBN2 (316) and the high voltage supply VDDIO 302 as resistor RN1 (312), and half between the NMOS bias_n transistors/diodes MNBN1 (314) and MNBN2 (316) and the low voltage supply VSS 304 as RN2 (320), the two NMOS bias_n transistors/NMOS diodes are effectively body-biased. The bias_n voltage output (308) may be placed at the junction/connection between the first bias_n resistor RN1 (312) and the first NMOS bias_n transistor/NMOS diode MNBN1 (314). Further, the NMOS transistors/diodes MNBN1 (314) and MNBN2 (316) may be implemented using enhancement mode NMOS transistors. Thus, the PVT adjusted bias_n voltage generation circuit 300 shown in FIG. 3A effectively generates a bias_n voltage substantially equal to the high voltage supply VDDIO 302 divided by two, with the threshold voltage of a NMOS transistor/diode device then added to the total as shown in Eq. 2 below, where “Vt_{NMOS}” represents the threshold voltage of a NMOS transistor/diode device.

$$Bias\_n = \frac{VDDIO}{2} + {Vt}_{NMOS} \qquad Eq . 2$$

Using Kirchhoff's laws, the bias_n voltage 308 generated by the PVT adjusted bias_n voltage generation circuit 300 may derived as follows in Eqs. 3-6 below, where “I” represents current flow through the bias_n generation circuit 300 and “Vt” represents the threshold voltage of the indicated NMOS transistor/diode device:

VDDIO=I×RN1+I×RN2+Vt_{MNBN1}+Vt_{MNBN2} Eq. 3

And since RN1=RN2=RN/2:

$$\begin{matrix}I = ( VDDIO - {Vt}_{MNBN 1} - {Vt}_{MNBN 2} ) / RN & Eq . 4 \\ \begin{matrix}Bias\_n = VDDIO - I \times RN 1 \\ = VDDIO - ( \frac{RN}{2} ) \times \frac{( VDDIO - {Vt}_{MNBN 1} - {Vt}_{MNBN 2} )}{RN}\end{matrix} & Eq . 5 \\ Bias\_n = \frac{VDDIO}{2} + \frac{{Vt}_{MNBN 1} + {Vt}_{MNBN 2}}{2} & Eq . 6\end{matrix}$$

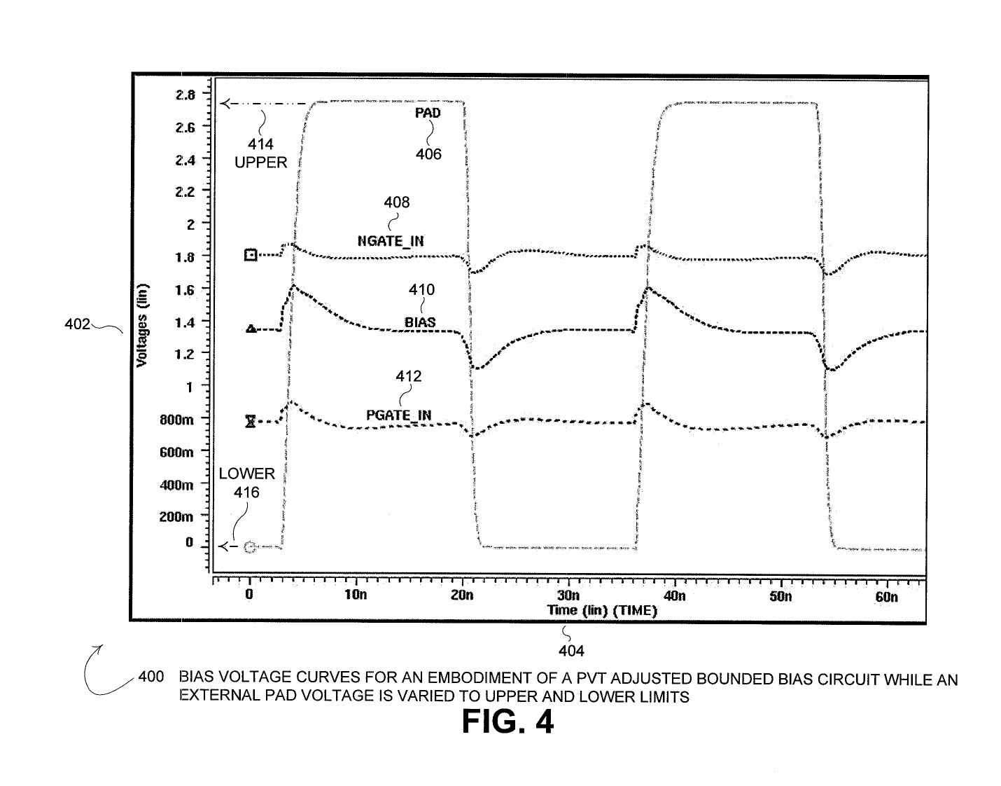

As effectively body-biased devices, the threshold voltage (Vt) of the active component NMOS transistors/diodes MNBN1 (314) and MNBN2 (316) vary with the PVT variations. Further, assuming the threshold voltages of the two NMOS transistors/diodes 314, 316 are substantially equal, makes Eq. 6 the same as Eq. 2. Thus, the bias_n equation (Eq. 2 and/or Eq. 6) is effectively the average of two body-biased devices 314, 316, which provides enhanced operation (see, for example, the description with respect to FIGS. 4-6 below). However, since the actual circuit uses two active devices in NMOS transistors/diodes MNBN1 (314) and MNBN2 (316), the actual bias equation is an average of the two body-biased devices 314, 316. Thus, it is ensured that the Vt component of the bias_n voltage output (308) tracks more closely the Vt component of MNBB1 (354) (see FIG. 3C) which is also body-biased providing for a better PVT response which otherwise would have almost shut off MNBB1 (354) (see FIG. 3C) in weak process corners without the body-bias having been taken into account.

FIG. 3B is an electrical schematic illustration of a PVT adjusted bias_p voltage generation circuit for an embodiment. As shown in FIG. 3B, in the PVT adjusted bias_p voltage generation circuit 380, resistor RP1 (334) is connected to the high supply voltage VDDIO 302 at one end and is further connected at the other end of resistor RP1 (334) to the source 344 of the first PMOS bias_p transistor MPBP1 (336). The gate 342 and drain 346 of the first PMOS bias_p transistor MPBP1 (336) is connected to the source 350 of the second PMOS bias_p transistor MPNBP2 (338). The gate 348 and drain 352 of the second PMOS bias_p transistor MPBP2 (348) are connected to one end of resistor RP2 (340) while the other end of resistor RP2 (340) is connected to the low voltage supply VSS 304. The common connection of resistor RP2 (340) and the gate 348 and drain 352 of the second PMOS bias_p transistor MPBP2 (338) is substantially an electrical node that is also the bias_p voltage that will be applied to the gate 364 of the first PMOS bounded bias circuit transistor MPBB1 (356) in FIG. 3C.

Resistors RP1 (334) and RP2 (340) should have substantially equal resistance values for the various embodiments. Thus, for an overall resistance of RP, RP1 (334) substantially equals one half of RP, and RP2 (340) also substantially equals one half of RP. It should be noted that it is not necessary for the overall resistance RP of the bias_p voltage generation circuit 380 shown in FIG. 3B to be equal to, or have a relative value to the overall resistance RN of the bias_n voltage generation circuit 300 shown in FIG. 3A. While not necessary, if the overall RP and RN resistance values are substantially equal, the various embodiments will still function as described herein and mathematically represented in Eqs. 2-11 herein. The PMOS bias_p transistors MPBP1 (336) and MPBP2 (338) are connected as PMOS diodes 336, 338 in series between the high voltage supply VDDIO 302 and the low voltage supply VSS 304 such that the PMOS diodes 336, 338 are placed such that current (i.e., the variable “I” in mathematical representations of the circuit) is permitted to flow from the high voltage supply VDDIO 302 to the low voltage supply VSS 304. The resistors RP1 (334) and RP2 (340) are also connected in series with the PMOS diodes 336, 338 such that RP1 (334) is placed between the transistor/diode MPBP1 (334) and VDDIO 302 and RP2 (340) is placed between the transistor/diode MPBP2 (338) and VSS 304. Thus, with the resistance RP split substantially in half between the PMOS bias_p transistors/diodes MPBP1 (336) and MPBP2 (338) and the high voltage supply VDDIO 302 as resistor RP1 (334), and half between the PMOS bias_p transistors/diodes MPBP1 (336) and MPBP2 (338) and the low voltage supply VSS 304 as RP2 (340), the two PMOS bias_p transistors/PMOS diodes are effectively body-biased. The bias_p voltage output (310) may be placed at the junction/connection between the second PMOS bias_p transistor/PMOS diode MPBP2 (338) and the second bias_p resistor RP2 (340). Further, the PMOS transistors/diodes MPBP1 (336) and MPBP2 (338) may be implemented using enhancement mode PMOS transistors. Thus, the PVT adjusted bias_p voltage generation circuit 380 shown in FIG. 3B effectively generates a bias_p voltage substantially equal to the high voltage supply VDDIO 302 divided by two, with the threshold voltage of a PMOS transistor/diode device then subtracted from the total as shown in Eq. 7 below, where “Vt_{pMos}” represents the threshold voltage of a PMOS transistor/diode device.

$$Bias\_p = \frac{VDDIO}{2} - {Vt}_{PMOS} \qquad Eq . 7$$

Using Kirchhoff's laws, the bias_p voltage 310 generated by the PVT adjusted bias_p voltage generation circuit 380 may derived as follows in Eqs. 8-11 below, where “I” represents current flow through the bias_p generation circuit 380 and “Vt” represents the threshold voltage of the indicated PMOS transistor/diode device:

VDDIO=I×RP1+I×RP2+Vt_{MPBP1}+Vt_{MPBP}2 Eq. 8

And since RP1=RP2=RP/2:

$$\begin{matrix}I = ( VDDIO - {Vt}_{MPBP 1} - {Vt}_{MPBP 2} ) / RP & Eq . 9 \\ \begin{matrix}Bias\_p = I \times RP 2 \\ = ( \frac{RP}{2} ) \times \frac{( VDDIO - {Vt}_{MPBP 1} - {Vt}_{MPBP 2} )}{RP}\end{matrix} & Eq . 10 \\ Bias\_p = \frac{VDDIO}{2} - \frac{{Vt}_{MPBP 1} + {Vt}_{MPBP 2}}{2} & Eq . 11\end{matrix}$$

As effectively body-biased devices, the threshold voltage (Vt) of the active component PMOS transistors/diodes MPBP1 (336) and MPBP2 (338) vary with the PVT variations. Further, assuming the threshold voltages of the two PMOS transistors/diodes 336, 338 are substantially equal, makes Eq. 11 the same as Eq. 7. Thus, the bias_p equation (Eq. 7 and/or Eq. 11) is effectively the average of two body-biased devices, which provides enhanced operation (see, for example, the description with respect to FIGS. 4-6 below). However, since the actual circuit uses two active devices in PMOS transistors/diodes MPBP1 (336) and MPBP (338), the actual bias equation is an average of the two body-biased devices 336, 338. Thus, it is ensured that the Vt component of the bias_p voltage output (310) tracks more closely the Vt component of MPBB1 (356) (see FIG. 3C) which is also body-biased providing for a better PVT.

FIG. 3C is an electrical schematic illustration of a bounded bias voltage circuit 390 based on PVT adjusted voltage inputs bias_n 308 and bias_p 310 generated by the various embodiments using circuits 300, 380 similar to those described in the disclosure with respect to FIGS. 3A and 3B above. In the circuit 390 shown in FIG. 3C, the bounded bias NMOS transistor MNBB1 (354) and the bounded bias PMOS transistor MPBB2 (356) provide active circuit components that may provide additional noise suppression for the overall circuit of FIGS. 3A-C. As shown in FIG. 3C the drain 360 of the bounded bias NMOS transistor MNBB1 (354) is connected to the high voltage supply VDDIO 302. The drain 368 of bounded bias PMOS transistor MPBB1 (356) is connected to the low voltage supply VSS 304. The source 362 of bounded bias NMOS transistor MNBB1 (354) is tied to the source 366 of bounded bias PMOS transistor MPBB1 (356). The connection of the sources 362, 266 of the bounded bias NMOS transistor MNBB1 (354) and the bounded bias PMOS transistor MPBB1 (356) are connected together to create a single electrical node that also operates to provide the bounded bias voltage output 306. Bias_n voltage input 308 from sub-circuit 300 shown in FIG. 3A is connected to the gate 358 of the bounded bias NMOS transistor MNBB1 (354) and bias_p voltage input 310 from sub-circuit 380 shown in FIG. 3B is connected to the gate 364 of the PMOS transistor MPBB1 (356). Thus, the bounded bias voltage, as adjusted for PVT variations by the bias_n voltage input 308 and the bias_p voltage input 310 (see, the description with respect to FIGS. 3A and 3B above for further explanation of the PVT adjustments of bias_n 308 and bias_p 310 voltages) is available for use by other systems/devices at the bounded bias voltage output 306.

A typical use for a PVT bounded bias voltage 306 may be to provide a lower voltage power supply for low voltage circuitry/devices from a high/higher voltage power supply for a high voltage device. Since the bounded bias voltage 306 of an embodiment has improved tracking with PVT variations, the lower voltage circuit is better able to track for process corners (i.e., worst case electrical system scenarios). Without proper PVT tracking for the threshold voltages (Vt), there is a risk of electrical currents in a circuit/device dropping to an unacceptably low value in a weak process corner. Thus, the PVT adjusted bounded bias voltage 306, permits a system to better avoid unacceptably low currents for weak process corners of low voltage circuits/devices.

FIG. 4 is graph 400 of bias voltage curves 408-412 for operation of an embodiment of a PVT adjusted bounded bias circuit while the external PAD 406 is cycled to upper 414 and lower 416 limits. The y-axis (i.e., the vertical axis) 402 represents volts/voltage and the x-axis (i.e., the horizontal axis) represents time. As may be seen in the graph 400, the ngate in voltage (i.e., bias_n voltage) 408, bias voltage 410, and the pgate_in voltage (i.e., bias_p voltage) 412, all remain relatively stable despite the significant swings in the voltage at the external PAD 406 from the upper limit 414 to the lower limit 416. Accordingly, it may be observed that a bounded bias voltage 410 of an embodiment as described herein is better able to withstand the potential variations of PVT (e.g., the extreme cycling of the external PAD voltage 406) that may be encountered by a real world system.

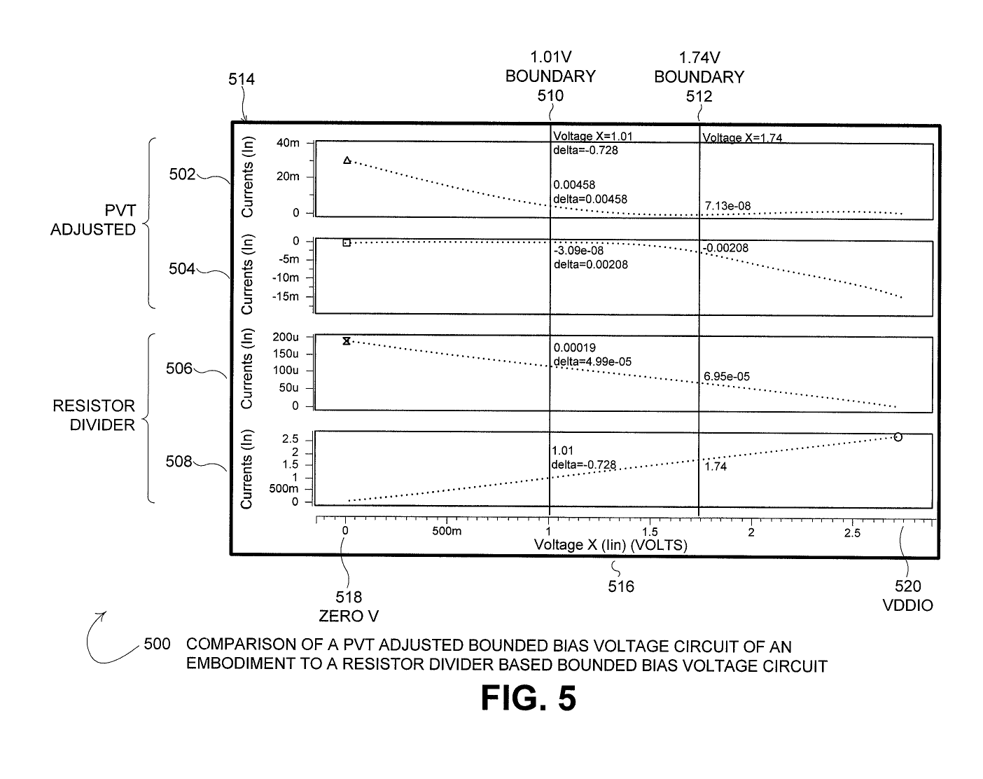

FIG. 5 is a graphical comparison 500 of operation of a PVT adjusted bounded bias voltage circuit of an embodiment (graphs 502 and 504) to a resistor divider based bounded bias voltage circuit (graphs 506 and 508). The y-axis (i.e., the vertical axis) 514 represents current for all four graphs 502-508 and the x-axis (i.e., the horizontal axis) 516 represents the bias voltage. For all four graphs 502-508, the bias voltage is ramped from zero volts (518) on up to match the high voltage supply VDDIO (at roughly 3V for graph 500) (520). Some variation of the bias voltage is expected in a real world circuit due to noise and other real world factors. Two boundaries at roughly 1.01V (510) and 1.74V (512) are also shown to provide reasonably expected process boundaries, which are roughly +/−350 mV from the expected/desired bias voltage of 1.37V. It may be observed that the resistor divider bias currents 506, 508 react as expected for resistors in Ohm's law where current equals voltage divided by resistance (I=V/R) and show a linear progression from a bias voltage of zero volts (518) to a bias voltage of VDDIO 520. Notably, the resistor divider bias voltages 506, 508 are not able to recover the bias voltage, even when crossing the two boundaries 510, 512. As expected according to Ohm's law, the resistor divider circuit will always source/sink the same current according to Ohm's law. However, the Metal-Oxide-Semiconductor (MOS) devices (i.e., PMOS, NMOS in the bias_n and bias_p voltage generation circuits described above with respect to FIGS. 3A and B) being active devices may switch/react to permit a swing from sourcing micro-amps to milli-amps when the bias voltage changes by a few tens of milli-volts. Accordingly, it may be observed that the graphs of the PVT adjusted bounded bias voltage circuit of an embodiment 502, 504 react in a roughly second-order graph such that the current between the 1.01V boundary (510) and the 1.74V boundary (512) remain relatively constant permitting the system to easily recover the bias voltage within the expected process boundaries 510. 512.

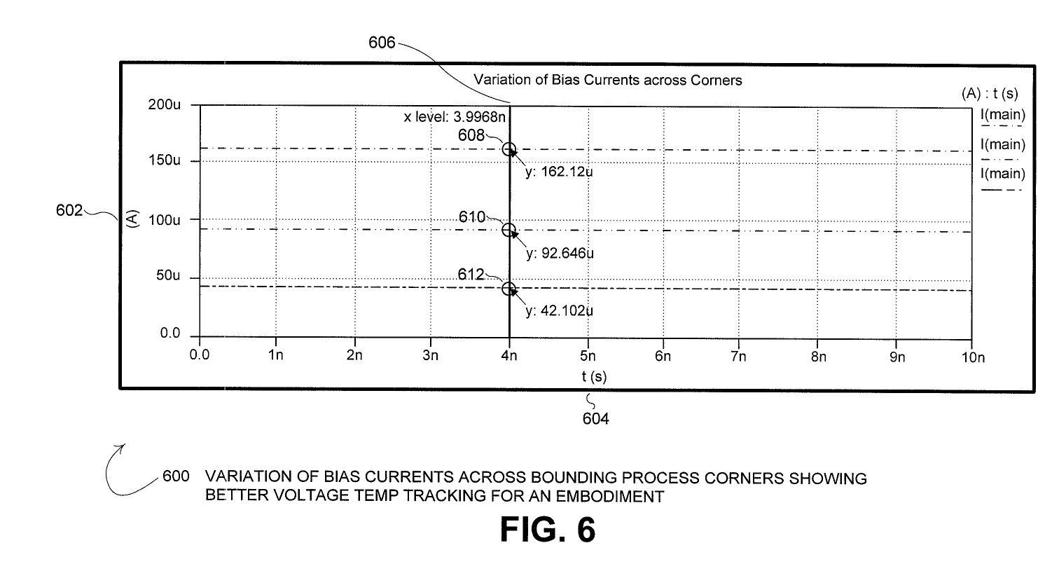

FIG. 6 is a graph 600 of bias currents 608-612 across bounding process corners showing better voltage temperature tracking for an embodiment. The y-axis (i.e., the vertical axis) 602 represents Amps (A) (i.e., current), and the x-axis (i.e., the horizontal axis) 604 represents time (i.e. nano-seconds). The time marker 606 is simply a location on the graph showing specific values for the process corner current lines 608-612. The lower most graph line 612 corresponds to a weak process corner, and without the body-bias tracking mechanism, the current can collapse to a negligible number (i.e., a few micro-amperes).

Various embodiments may be implemented using components that have substantially electrically similar characteristics. For instance, in place of one resistor, multiple resistors may be included that together have the same resistance characteristics as the resistors described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method to provide a bounded bias voltage with improved Process-Voltage-Temperature (PVT) adjustment comprising:
generating a PVT adjusted bias_n voltage at a bias_n output of a bias_n voltage generation circuit that adjusts for Process-Voltage-Temperature (PVT) as a function of temperature affected voltages of a first bias_n NMOS diode (MNBN1) and a second bias_n NMOS diode (MNBN2), said generation of said bias_n voltage further comprising:
connecting in series between a high voltage supply (VDDIO) and a low voltage supply (VSS) the following electrical components in the following order: a first bias_n resistor (RN1), a first bias_n NMOS diode (MNBN1), a second bias_n NMOS diode (MNBN2), and a second bias_n resistor (RN2), connected such that said first bias_n NMOS diode (MNBN1) and said second bias_n NMOS diode (MNBN2) are placed to permit current to flow from said high voltage supply (VDDIO) to said low voltage supply (VSS) and a resistance of said first bias_n resistor (RN1) is substantially equal to a resistance of said second bias_n resistor (RN2);
connecting said bias_n voltage output substantially electrically at said junction/connection between said first bias resistor (RN1) and said first bias_n NMOS diode (MNBN1) in order to permit Process-Voltage-Temperature (PVT) variations of threshold voltages that vary with temperatures of said first (MNBN1) and said second (MNBN2) bias_n NMOS diodes to vary said PVT adjusted bias_n voltage at said bias_n voltage output; and
operating said high voltage supply (VDDIO) and said low voltage supply (VSS) such that said PVT adjusted bias_n voltage is generated at said bias_n output of said bias_n voltage generation circuit;
generating a PVT adjusted bias_p voltage at a bias_p output of a bias_p voltage generation circuit as a function of temperature affected voltages of a first bias_p PMOS transistor (MPBP1) and a second bias_p PMOS transistor (MPBP2), said generation of said bias_p voltage further comprising:
connecting in series between said high voltage supply (VDDIO) and said low voltage supply (VSS) the following electrical components in the following order: a first bias_p resistor (RP1), a first bias_p PMOS diode (MPBP1), a second bias_p PMOS diode (MPBP2), and a second bias_p resistor (RP2), connected such that said first bias_p PMOS diode (MPBP1) and said second bias_p PMOS diode (MPBP2) are placed to permit current to flow from said high voltage supply (VDDIO) to said low voltage supply (VSS) and a resistance of said first bias_p resistor (RP1) is substantially equal to a resistance of said second bias_p resistor (RP2);
connecting said bias_p voltage output substantially electrically at said junction/connection between said second bias_p PMOS diode (MPBP2) and said second bias_p transistor (RP2) in order to permit Process-Voltage-Temperature (PVT) variations of threshold voltages that vary with temperatures of said first (MPBP1) and said second (MPBP2) bias_p PMOS diodes to vary said PVT adjusted bias_p voltage at said bias_p voltage output; and
operating said high voltage supply (VDDIO) and said low voltage supply (VSS) such that said PVT adjusted bias_p voltage is generated at said bias_p output of said bias_p generation voltage generation circuit;
generating a PVT adjusted bounded bias voltage at a bounded bias voltage output of a bounded bias voltage generation circuit, said generation of said bounded bias voltage further comprising:
connecting a drain of a first bounded bias NMOS transistor (MN1) to said high voltage supply (VDDIO);
connecting a gate of said first bounded bias NMOS transistor (MN1) to said bias_n voltage output of said bias_n voltage generation circuit such that said PVT adjusted bias_n voltage is applied to said gate of said first bounded bias NMOS transistor (MN1);
connecting a source of said first bounded bias NMOS transistor (MNBB 1) to a source of a first bounded bias PMOS transistor (MPBB1) such that said common connection of said source of said first bounded bias NMOS transistor (MNBB 1) and said source of said first bounded bias PMOS transistor (MPBB 1) substantially electrically comprise said bounded bias voltage output of said bounded bias voltage generation circuit;
connecting a gate of said first bounded bias PMOS transistor (MPBB 1) to said bias_p voltage output of said bias_p voltage generation circuit such that said PVT adjusted bias_p voltage is applied to said gate of said first bounded bias PMOS transistor (MPBB1);
connecting a drain of said first bounded bias PMOS transistor (MPBB1) to said low voltage supply (VSS); and
operating said high voltage supply (VDDIO), said low voltage supply (VSS), said bias_n voltage generation circuit, and said bias_p voltage generation circuit such that said PVT adjusted bounded bias voltage is generated at said bounded bias voltage output of said bounded bias voltage generation circuit.

2. The method of claim 1 wherein said first (MNBN1) and said second (MNBN2) bias_n NMOS diodes are implemented using NMOS transistors having a gate, drain and source.

3. The method of claim 2 wherein said first (MNBN1) and said second (MNBN2) bias_n NMOS transistors are enhancement mode NMOS transistors.

4. The method of claim 2 wherein said process of connecting in series between said high voltage supply (VDDIO) and said low voltage supply (VSS) said first bias_n resistor (RN1), said first bias_n NMOS diode (MNBN1), said second bias_n NMOS diode (MNBN2), and said second bias_n resistor (RN2) further comprises:
connecting a first end of said first bias_n resistor (RN1) to said high voltage supply (VDDIO);
connecting a second end of said first bias_n resistor (RN1) to said drain and said gate of said first bias_n NMOS transistor (MNBN1) such that said common connection of said second end of said first bias_n resistor (RN1), said drain of said first bias_n NMOS transistor (MNBN1), and said gate of said first bias_n NMOS transistor (MNBN1) substantially electrically comprise said bias_n output of said bias_n voltage generation circuit;
connecting said source of said first bias_n NMOS transistor (MNBN1) to said drain and said gate of said second bias_n NMOS transistor (MNBN2);
connecting said source of said second bias_n NMOS transistor (MNBN2) to a first end of a second bias_n resistor (RN2); and
connecting a second end of said second bias_n resistor (RN2) to said low voltage supply (VSS).

5. The method of claim 1 wherein said first (MPBP1) and said second (MPBP2) bias_p PMOS diodes are implemented using PMOS transistors having a gate, drain and source.

6. The method of claim 5 wherein said first (MPBP1) and said second (MPBP2) bias_p PMOS transistors are enhancement mode PMOS transistors.

7. The method of claim 5 wherein said process of connecting in series between said high voltage supply (VDDIO) and said low voltage supply (VSS) said first bias_p resistor (RP1), said first bias_p PMOS diode (MPBP1), said second bias_p PMOS diode (MPBP2), and said second bias_p resistor (RP2) further comprises:
connecting a first end of said first bias_p resistor (RP1) to said high voltage supply (VDDIO);
connecting a second end of said first bias_p resistor (RP1) to said source of said first bias_p PMOS transistor (MPBP1);
connecting said gate and said drain of said first bias_p PMOS transistor (MPBP1) to said source of said second bias_p PMOS transistor (MPBP2);
connecting said drain and said gate of said second bias_p PMOS transistor (MPBP2) to a first end of said second bias_p resistor (RP2) such that said common connection of said first end of said second bias_p resistor (RP2), said drain of said second bias_p PMOS transistor (MPBP2), and said gate of said second bias_p PMOS transistor (MPBP1) substantially electrically comprise said bias_p output of said bias_p voltage generation circuit); and,
connecting a second end of said second bias_p resistor (RP2) to said low voltage supply (VSS).

8. The method of claim 1 further comprising: supplying a low voltage device/circuit using said bounded bias voltage with improved Process-Voltage-Temperature (PVT) based on said high voltage supply (VDDIO) and said low voltage supply (VSS) of a high voltage device.

9. The method of claim 1 wherein said low voltage supply (VSS) represents electrical ground.

10. A bounded bias voltage apparatus that provides a bounded bias voltage with improved Process-Voltage-Temperature (PVT) adjustment comprising:
a bias_n voltage generation circuit that generates a PVT adjusted bias_n voltage at a bias_n output of said bias_n voltage generation circuit that adjusts for Process-Voltage-Temperature (PVT) as a function of temperature affected voltages of a first bias_n NMOS diode (MNBN1) and a second bias_n NMOS diode (MNBN2), said bias_n voltage generation circuit further comprising:
a first bias_n resistor (RN1), a first bias_n NMOS diode (MNBN1), a second bias_n NMOS diode (MNBN2), and a second bias_n resistor (RN2) connected in order in series between a high voltage supply (VDDIO) and a low voltage supply (VSS), further connected such that said first bias_n NMOS diode (MNBN1) and said second bias_n NMOS diode (MNBN2) are placed to permit current to flow from said high voltage supply (VDDIO) to said low voltage supply (VSS) and a resistance of said first bias_n resistor (RN1) is substantially equal to a resistance of said second bias_n resistor (RN2), said bias_n voltage output connected substantially electrically at said junction/connection between said first bias resistor (RN1) and said first bias_n NMOS diode (MNBN1) in order to permit Process-Voltage-Temperature (PVT) variations of threshold voltages that vary with temperatures of said first (MNBN1) and said second (MNBN2) bias_n NMOS diodes to vary said PVT adjusted bias_n voltage at said bias_n voltage output, and such that operation of said high voltage supply (VDDIO) and said low voltage supply (VSS) generates said PVT adjusted bias_n voltage at said bias_n output of said bias_n voltage generation circuit;
a bias_p voltage generation circuit that generates a PVT adjusted bias_p voltage at a bias_p output of said bias_p voltage generation circuit as a function of temperature affected voltages of a first bias_p PMOS transistor (MPBP1) and a second bias_p PMOS transistor (MPBP2), said bias_p voltage generation circuit further comprising:
a first bias_p resistor (RP1), a first bias_p PMOS diode (MPBP1), a second bias_p PMOS diode (MPBP2), and a second bias_p resistor (RP2) connected in order in series between said high voltage supply (VDDIO) and said low voltage supply (VSS), further connected such that said first bias_p PMOS diode (MPBP1) and said second bias_p PMOS diode (MPBP2) are placed to permit current to flow from said high voltage supply (VDDIO) to said low voltage supply (VSS) and a resistance of said first bias_p resistor (RP1) is substantially equal to a resistance of said second bias_p resistor (RP2), said bias_p voltage output connected substantially electrically at the junction/connection between said second bias_p PMOS diode (MPBP2) and said second bias_p transistor (RP2) in order to permit Process-Voltage-Temperature (PVT) variations of threshold voltages that vary with temperatures of said first (MPBP1) and said second (MPBP2) bias_p PMOS diodes to vary said PVT adjusted bias_p voltage at said bias_p voltage output, and such that operation of said high voltage supply (VDDIO) and said low voltage supply (VSS) generates said PVT adjusted bias_p voltage at said bias_p output of said bias_p generation voltage generation circuit;
a bounded bias voltage generation circuit that generates a PVT adjusted bounded bias voltage at a bounded bias voltage output of said bounded bias voltage generation circuit, said bounded bias voltage generation circuit further comprising:
a first bounded bias NMOS transistor (MNBB 1) having a drain connected to said high voltage supply (VDDIO), having a gate connected to said bias_n voltage output of said bias_n voltage generation circuit such that said PVT adjusted bias_n voltage is applied to said gate of said first bounded bias NMOS transistor (MNBB1);
a first bounded bias PMOS transistor (MPBB1) having a source connected to a source of said first bounded bias NMOS transistor (MNBB1) such that said common connection of said source of said first bounded bias NMOS transistor (MNBB1) and said source of said first bounded bias PMOS transistor (MPBB1) substantially electrically comprise said bounded bias voltage output of said bounded bias voltage generation circuit, said first bounded bias PMOS transistor (MPBB1) further having a gate connected to said bias_p voltage output of said bias_p voltage generation circuit such that said PVT adjusted bias_p voltage is applied to said gate of said first bounded bias PMOS transistor (MPBB1), said first bounded bias PMOS transistor (MPBB1) further having a drain connected to said low voltage supply (VSS), and such that operation of said high voltage supply (VDDIO), said low voltage supply (VSS), said bias_n voltage generation circuit, and said bias_p voltage generation circuit generates said PVT adjusted bounded bias voltage at said bounded bias voltage output of said bounded bias voltage generation circuit.

11. The bounded bias voltage apparatus of claim 10 wherein said first (MNBN1) and said second (MNBN2) bias_n NMOS diodes are implemented using NMOS transistors having a gate, drain and source.

12. The bounded bias voltage apparatus of claim 11 wherein said first (MNBN1) and said second (MNBN2) bias_n NMOS transistors are enhancement mode NMOS transistors.

13. The bounded bias voltage apparatus of claim 11 wherein said bias_n voltage generation circuit further comprises:
a first end of said first bias_n resistor (RN1) connected to said high voltage supply (VDDIO), a second end of said first bias_n resistor (RN1) connected to said drain and said gate of said first bias_n NMOS transistor (MNBN1) such that said common connection of said second end of said first bias_n resistor (RN1), said drain of said first bias_n NMOS transistor (MNBN1), and said gate of said first bias_n NMOS transistor (MNBN1) substantially electrically comprise said bias_n output of said bias_n voltage generation circuit, said source of said first bias_n NMOS transistor (MNBN1) connected to said drain and said gate of said second bias_n NMOS transistor (MNBN2),
said source of said second bias_n NMOS transistor (MNBN2) connected to a first end of a second bias_n resistor (RN2), and a second end of said second bias_n resistor (RN2) connected to said low voltage supply (VSS).

14. The bounded bias voltage apparatus of claim 10 wherein said first (MPBP1) and said second (MPBP2) bias_p PMOS diodes are implemented using PMOS transistors having a gate, drain and source.

15. The bounded bias voltage apparatus of claim 14 wherein said first (MPBP1) and said second (MPBP2) bias_p PMOS transistors are enhancement mode PMOS transistors.

16. The bounded bias voltage apparatus of claim 14 wherein said bias_p voltage generation circuit further comprises:
a first end of said first bias_p resistor (RP1) connected to said high voltage supply (VDDIO), a second end of said first bias_p resistor (RP1) connected to said source of said first bias_p PMOS transistor (MPBP1), said gate and said drain of said first bias_p PMOS transistor (MPBP1) connected to said source of said second bias_p PMOS transistor (MPBP2), said drain and said gate of said second bias_p PMOS transistor (MPBP2) connected to a first end of said second bias_p resistor (RP2) such that said common connection of said first end of said second bias_p resistor (RP2), said drain of said second bias_p PMOS transistor (MPBP2), and said gate of said second bias_p PMOS transistor (MPBP1) substantially electrically comprise said bias_p output of said bias_p voltage generation circuit), and a second end of said second bias_p resistor (RP2) connected to said low voltage supply (VSS).

17. The bounded bias voltage apparatus of claim 10 wherein said bounded bias voltage supplies a low voltage device/circuit with improved Process-Voltage-Temperature (PVT) based on said high voltage supply (VDDIO) and said low voltage supply (VSS) of a high voltage device.

18. The bounded bias voltage apparatus of claim 10 wherein said low voltage supply (VSS) represents electrical ground.
